(19) United States
(12) Patent Application Publication
(10) Pub. No.: US 2016/0017611 A1
(43) Pub. Date: Jan. 21, 2016

(54) STAIR AND RAMP MOBILITY APPARATUS HAVING SECURE TRANSITION METHOD

(71) Applicants: Joel Douglas, Groton, CT (US); Jeffry Tola, Canterbury, CT (US)

(72) Inventors: Joel Douglas, Groton, CT (US); Jeffry Tola, Canterbury, CT (US)

(21) Appl. No.: 14/814,538

(22) Filed: Jul. 31, 2015

Related U.S. Application Data
(63) Continuation-in-part of application No. 14/312,987, filed on Jun. 24, 2014.
(60) Provisional application No. 62/038,420, filed on Aug. 18, 2014.

(51) Int. Cl. E04F 11/18; H04W 4/00

(52) U.S. Cl. CPC E04F 11/1863; H04W 4/008

(57) ABSTRACT

This invention relates to a stair assist apparatus for assisting individuals to move up or down stairs, ramps or inclined structures and is connected to a wireless communication system that can provide status and location of the apparatus or the individual using the apparatus to a remotely located caregiver. The wireless communication systems within this invention contains at least one transmitter and one receiver capable of communicating voice or analog or digital formatted information of the state of sensors incorporated into the stair assist device. The stair assist apparatus also provides a secure transition for the person at both the top and bottom of the stair or ramp so that they can make the last steps with the help of the assist of the apparatus.

### 1. CROSS REFERENCE TO RELATED APPLICATIONS

This application claims priority to U.S. Provisional Patent Application Ser. No. 62/038,420, filed 18 Aug. 2014, entitled “Stair and Ramp Mobility Apparatus Having Secure Transition Method” and co-pending application Ser. No. 14/312,987, filed 24 Jun. 2014, entitled “Smart Monitoring Sensor System For Monitoring Mobility”, “the contents of which are both incorporated herein by reference in their entirety.

### 2. FIELD OF THE INVENTION

This invention relates to an apparatus for assisting individuals to move up or down stairs, ramps or inclined structures and is connected to a wireless communication system that can provide status and location of the apparatus or the individual using the apparatus to a remotely located caregiver. Inclined structures are defined within this invention to mean stairs, ramps or other inclined structures used by individuals to move to different levels within a structure. Wireless communication systems are defined within this invention as containing at least one transmitter and one receiver capable of communicating voice or analog or digital formatted information of the state of sensors between the two without physically wired connections using radio frequency, or infrared modulation or near field communication or ultrasonic or visible light modulation or other wireless broadcast technologies. Sensors are defined in this invention as any device that changes state due to a change in a physical parameter of components comprising the apparatus or attached to the apparatus or the individual. Sensors can include but are not limited to a device that generates a simple binary output representing two or more predefined conditions of the parameter being monitored or a device that generates a digital or analog value representing the relative or absolute value of the parameter being monitored. The wireless communication system provides real time transmission of the apparatus and the individual's location and status. Stair assist apparatus is defined within this invention to mean an apparatus to assist an individual to move to different levels within a structure. The stair assist apparatus of this invention is designed to support an individual person as they move either up or down the stairs, ramp or inclined structure. The apparatus includes a movable support having a cross-rail assembly including bars or grips to provide continuous handheld support to the individual as they traverse the rail, stair or inclined structure. The invention provides support along the length of the inclined structure and discrete positions along the inclined structure where the assist apparatus can be temporarily locked and the user can rest while being supported by the assist apparatus or the user can gain leverage for movement to the next step. These rest positions provide the alternative benefit of providing stopping positions for the assist apparatus if the user falls or stumbles. In addition, the invention provides a harness assembly that when worn by the user and secured to the assist apparatus will retain the user's attachment to the apparatus and therefore prevent movement beyond the stopping positions in the event where the user loses grip of the cross-rail assembly. The assist apparatus also provides a secure transition for the person at both the top and bottom of the stair or ramp so that they can make the last steps with the assist of the apparatus.

### 3. BACKGROUND OF THE INVENTION

Many people, and especially the elderly, have various ailments which cause their legs or back, including knees and hips to be weak. Such ailments of the joints and, more specifically, of the knee joints, typically occur as a result of a degenerative disease such as arthritis. As a result, such people often experience difficulty in supporting their own weight and, more particularly, in walking up and down stairs and inclined structures. Many of these individuals also have caregivers who have an interest in knowing where the individual is with respect to traversing the inclined structures, stairs or ramp.

The difficulty people experience in walking up and down stairs limits their mobility in public buildings as well as in their home. Consequently, a need exists in the art for an apparatus which would aid the individuals with stair climbing mobility problems to walk up and down stairs, ramps and inclined structures. In addition, there is a need for such an apparatus which would be inexpensive and would be useful in public buildings as well as in private homes. Further in addition, there is a need for such an apparatus which would not interfere with the normal activities of people who do not ordinarily need to use such an apparatus. Further there is a need for the caregiver to be updated as to progress of an individual is with respect to traversing the stairs or ramp.

Additionally, many of the people utilizing the apparatus are in need of regular supervision by a caregiver. Often the caregivers cannot provide uninterrupted monitoring of the user therefore remote notification of the status of the apparatus and the individual is required. Among the items that need remote monitoring are when a stair assist apparatus has been used by one person there exists a need to notify the caregiver if a second individual needs the stair assist apparatus and it is stored in a distal position from the individual needing to use the stair assist device, when a user is in transit between the top and bottom landings, the elapsed time of the user's motion between the top and bottom landings, when the user has fallen, when the user has stopped on a step, user's physiological conditions such as heart rate, or body temperature and when assistance is needed either to help a person transit the inclined structure or to notify the caregiver that they need assistance moving the stair assist apparatus. Examples of physiological sensors include Polar H7 Bluetooth Low Energy heart rate monitor or the Zephyr Technology's BioHarness BT sensor technology is capable of biometric monitoring including blood oxygen, ECG, and blood pressure. A wireless communication system configured with sensors and two way information exchanges can provide real time monitoring of these physiological conditions and other needs to a caregiver or user remotely located from the assist apparatus.

Secondly the transition to the landing at the top of the inclined structures or the bottom of inclined structures is a critical need for people with limited mobility as they navigate stairs. Prior art inventions require the person to take the last step unassisted or the assist apparatus interferes with the free flow of movement of the persons utilizing the landings at either the top or bottom of the inclined structures. Therefore, there is a need for such an apparatus which supports a person during the transition from the inclined structure to the landing at either the top or the bottom of the inclined structure and transmitting to the caregiver that the transition to the applicable landing has been done.

Systems have also been developed that provide support for the user to move up and down the stairs such as U.S. Pat. No. 5,957,146 Movable Banister issued to Corey, U.S. Pat. No. 7,950,498 Stair Climbing Aid issued to Yang, et al., U.S. Pat. No. 7,870,695 Support Apparatus and Method for Assisted Traversal of a Structure issued to Manson, et al. These patents all provide a movable support which can be selectively positioned relative to the fixed support in one of a plurality of closely-spaced discrete locking positions in which the movable support can support a person relative to the their position on stairs.

Using U.S. Pat. No. 7,950,498 Stair Climbing Aid issued to Yang as an example, while providing a locking mechanism at each stair, it comprises two slide rails, an assist member, a control mechanism and two positioning assemblies. The slide rails and the assist member are assembled to handrails on both sides of the stairs. The control mechanism is disposed on the assist member to be controlled by the user. The positioning assemblies are disposed at both sides of the assist member, each positioning assembly is provided with an engaging portion to be engaged in the respective positioning portions of the slide rail. Thereby, an anti-slide effect is produced, so as to prevent the user from falling down the stairs and to help the user move from step to step safely. However, these anti slide mechanisms still require the user to retain grip of the slide rail assembly to prevent the user from falling down the stairs. The strength and motor skills required to retain their grip are likely not available as their absence is precisely the reason the apparatus is being used.

The two side rail and cross members make safe and controlled transitioning to the top landing and bottom landing difficult for the person using this assist apparatus. They also require competent motor skills to store the cross members and prepare the stairway for use by people not needing the apparatus. As in the example of a loss of grip scenario, the required motor skills needed to transition the top and bottom landings are likely not available as their absence is precisely the reason the apparatus is being used.

### 4. SUMMARY OF THE INVENTION

It is a first object of the present invention to provide a stairway assist product that overcomes some or all of the previously mentioned drawbacks of prior stairway assist products and provides a caregiver with the status on movement by the individual using the stair assist device. Prior stairway assist products do not provide a means of securely moving from the top step to the top landing or from the bottom step to the bottom landing. The invention provides a solution by allowing the person to hold the cross-rail grips while descending to the bottom landing or ascending to the top landing. The present invention solves this problem by providing a stairway assist apparatus which rotates radially about secure positions at the top and bottom landings. The user can maintain their grip on the cross-rail as it rotates and clears a path on the landing. Additionally the present invention includes multiple positions for holding on to the cross-rail so that the person is not reaching up or bending down when ascending and descending the stairs. The invention provides up to three or more rails at different heights relative to the user allowing the person to use either rail for support as they ascend or descend. This also allows people of differing height to use the apparatus.

The invention also anticipates the need to prevent a catastrophic fall resulting from a complete or momentary loss of grip on the cross-rail member by the user. The present invention solves this problem by integrating a removable harness worn by the user and secured to the assist apparatus. In the event the user loses grip on the cross-rail and becomes unstable or falls during their movement up or down the inclined surface, the harness will secure the user to the cross-rail assembly and prevent the user from falling beyond the next locking position.

In addition, the invention also anticipates the storage of the grips of the assist apparatus so that another person who does not need an assist apparatus can use the stairs without using the assist apparatus. The ability to swing and lock the cross-rail so that it is parallel to the wall of the stairs or ramp allows the cross-rail to be moved out of the way for other persons using the stairs or ramp. The cross-rail can then be easily swung back into place and locked for the user in his or her return trip.

Anticipated as well is the need for caregivers, homeowners and facility managers to monitor use of the apparatus and therefore presence and activity of persons on the inclined structure or provide a means of notifying the caregiver that the person needs help. Additionally a means of remote monitoring is included. This can be a radio transmitted signal broadcast to the patient or facility monitor when the cross-rail is not in its bottom or top resting positions. Additionally other sensors and monitoring functions can be attached to interpret status of the person using the apparatus. Some features may include time monitoring to determine if the user has stopped or arrived at an unpredicted time. These time measurements can also be used to monitor rehabilitation status of users.

Additionally a means for enabling a stair assist apparatus to provide a means to notify the caregiver if a second individual needs the stair assist apparatus when it is stored in a distal position need by the individual. Such a call device wirelessly linked by way of a wireless means to the caregiver provides the additional ability to notify the caregiver that assistance is needed either to help a person transit the stairs, ramp or notify them that they need assistance moving the stair assist apparatus so they can use it. The term ‘Wireless’ means that the transmitter and receiver utilizes a wireless protocol selected from the group consisting IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or other radio frequency system.

### 5. BRIEF DESCRIPTION OF THE DRAWINGS

FIG. 1 is a perspective view of the invention being used by a person.

FIG. 2 is a perspective view of a support rail track and adjustable stops.

FIG. 3 is a perspective view of a cross-rail assembly.

FIG. 4 is a perspective view of a moveable support

FIG. 5 is a perspective view of the invention being used by a person at the top of the stairs

FIG. 6 is a perspective view of the invention being used by a person at the bottom of the stairs

FIG. 7 Wireless alarm device

FIG. 8 Wireless device details

FIG. 9 is a perspective view of a second articulating cross-rail assembly with a removable harness

FIG. 10 is a close up view of locking mechanisms

FIG. 11 is a plan view of the second articulating member positions

FIG. 12 is a schematic showing the typical remote transmitter device

FIG. 13A is a perspective view of the typical remote transmitter

FIG. 13B is a exploded view showing the more detailed view of typical remote transmitter device

FIG. 14 A is a wireless receiver linking screen

FIG. 14 B is a wireless receiver linking screen linked as stair assist sensor bottom of stairs

### 6. DETAILED DESCRIPTION OF THE INVENTION

Inclined structures are defined within this invention to mean stairs, ramps or other inclined structures used by individuals to move to different levels within a structure.

This specification utilizes the terms individual, person, patient, resident or user interchangeably to mean the same thing which is an individual that utilizes a stair assist apparatus.

Sensor technology used to detect the apparatus position can be selected from mechanical contacting switches, magnetic, inductive, capacitive, passive infrared, infrared, linear variable displacement transducer, magnetic, inductive, capacitive, optical, shock, vibration, accelerometer etc. devices, or others.

Stair assist apparatus is defined within this invention to mean an apparatus to assist an individual to move to different levels within a structure.

The term Wireless means the wireless transmitter and receiver utilizes a wireless protocol selected from the group consisting IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or other radio frequency system.

Pitch of stairs or ramp is the angle of the stairs or ramp which is formed by the incline of the stairs or ramp.

A grip or bar is defined as a handle on a stair assist apparatus used by a patient or resident who needs mobility support to move to different levels within a structure.

Low-friction carriage means a carriage that rides on the corresponding track with rollers, ball bearings, low friction plastic slides, Teflon slides, Delran slides or air bearings.

A caregiver is a person or persons who are caring for a patient or resident who needs mobility support.

Mobility support is support provided an individual to help them move from one location to another using their own legs by walking.

Mobility impaired individuals are those individuals that need mobility support.

Status information is information provided to a caregiver about the first locking pin, movable support, the cross-rail assembly, the second movable support or the user with respect to the fixed support such that said status information is transmitted to said wireless receiver.

Location information is information provided to a caregiver about the locking pin, first movable support, the cross-rail assembly, the second movable support or the user with respect to the fixed support such that said location information is transmitted to said wireless receiver.

Physiological conditions refers to conditions of the external or internal milieu that may occur in nature for an individual and include measurements of body temperature, heart rate monitor, blood oxygen, ECG, and blood pressure monitoring, weight, pulse.

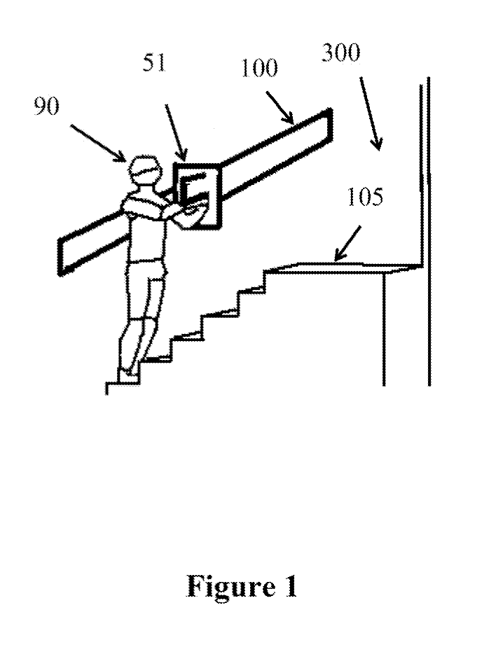

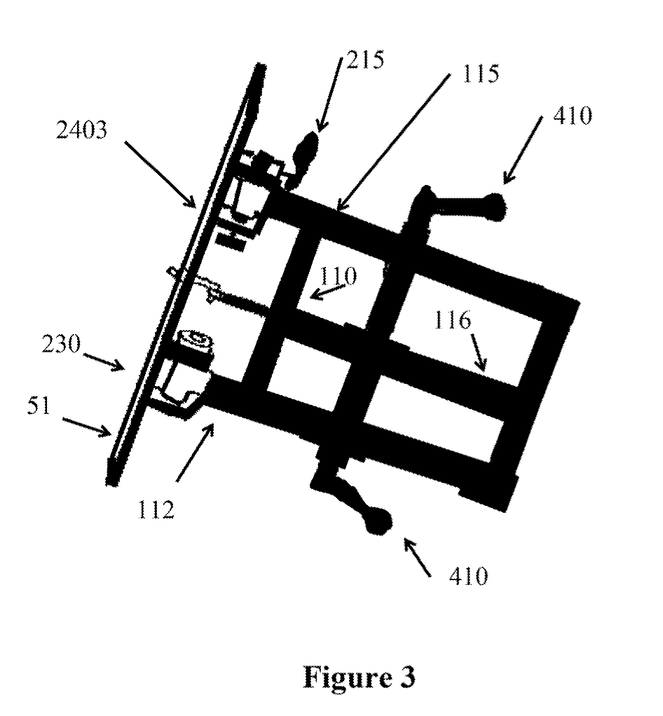

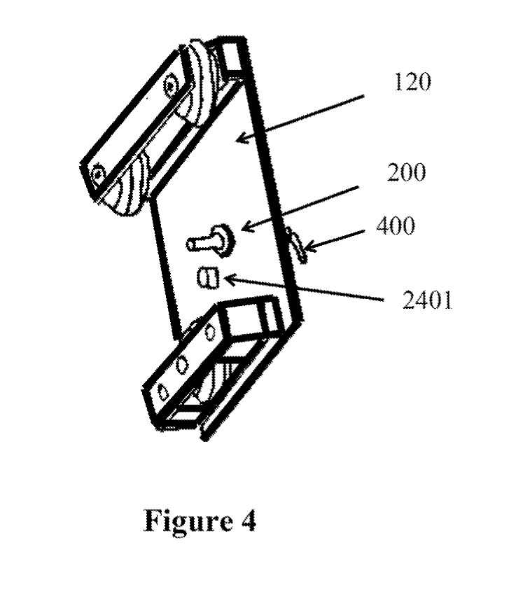

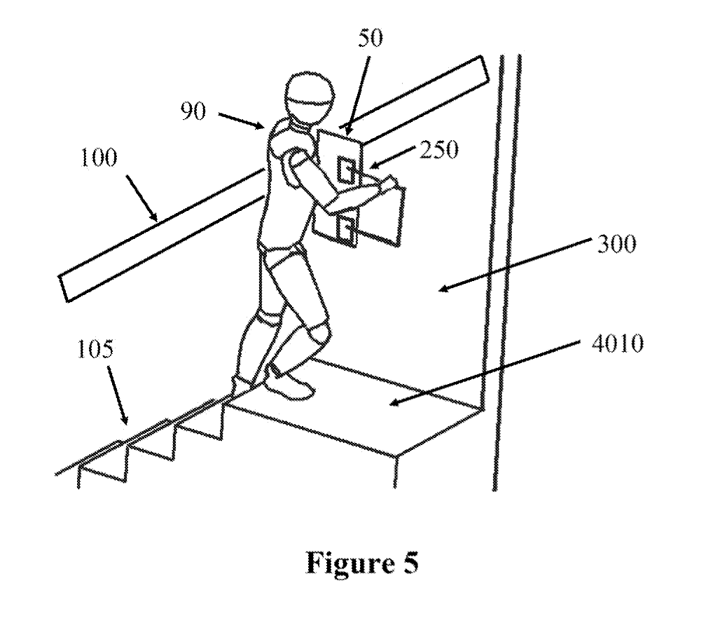

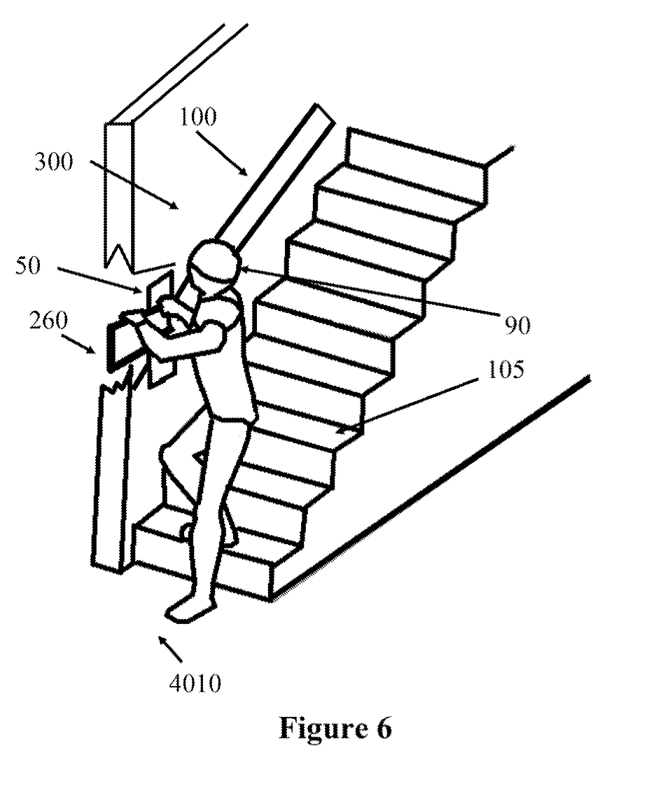

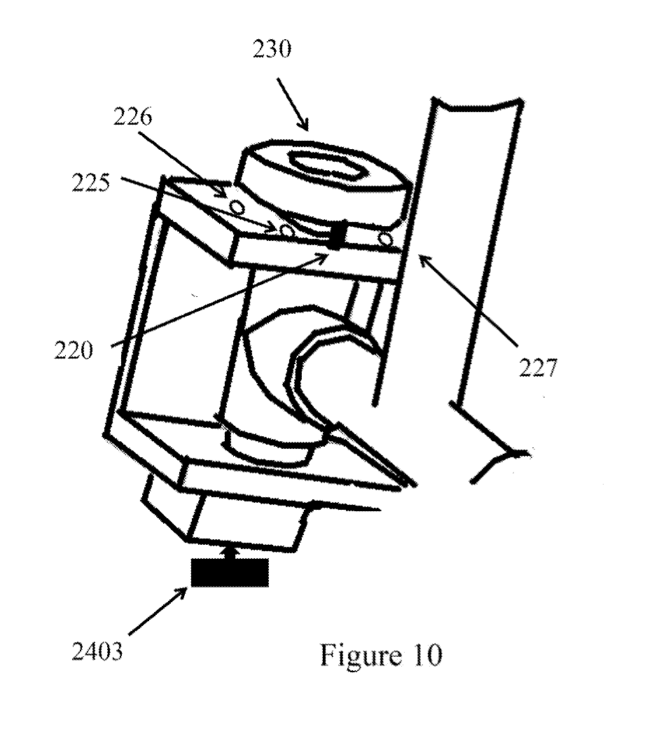

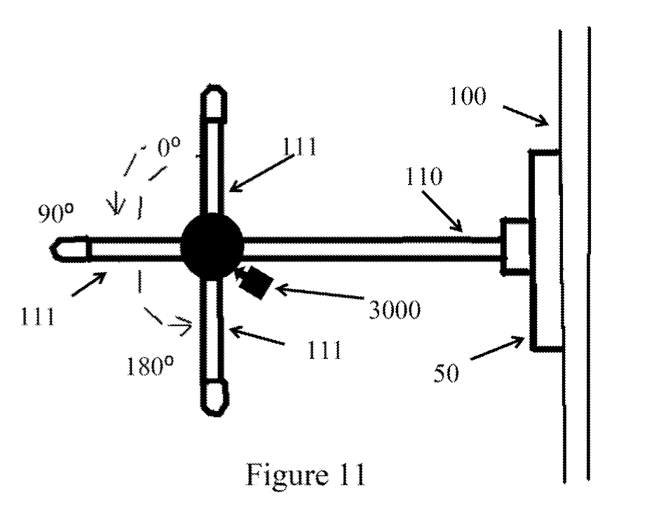

Using FIGS. 1, 2, 3, 4, 5, 6, 9, 10 and 11 it is shown that the invention helps mobility impaired individuals to traverse an inclined structure either up or down using stairs, ramps or inclined structures. It also provides an assist apparatus 50 to reduce the incidence of inclined structure falls and is capable of providing feedback by using a wireless transmitter 1000 to signal to the remote wireless receiver 2000 to provide information to a caregiver not shown on the progress a mobility impaired individual is making using the assist apparatus 50 and the status of the articulation of support members that make up assist apparatus 50. While many mobility impaired individuals can live full and meaningful lives with the help of a caregiver the mobility impaired individuals and caregiver may have conflicting needs during the course of a day and the ability to know the progress a mobility impaired individual is making with an assist apparatus 50 is important to the caregiver and the mobility impaired individual's relationship with the caregiver. Therefore an assist apparatus 50 is comprised of a fixed support rail track 100 that is attached to a wall or banisters running parallel to the pitch of the stairs 105 or ramp 106. A first moveable support 51 formed from a cross-rail assembly 110, parallel to the pitch of the stairs 105 or the ramp 106 and extending perpendicularly from fixed support rail track 100 which is positioned 900 as shown in FIG. 11, slides along the track by means of a matching high strength, low-friction carriage 120 to which is attached cross-rail assembly 110 having a grip or bar 112 and a separate grip or bar 115 as part of the first moveable support 51. A person 90 will hold onto the cross-rail assembly 110 (directly in front of them) for stability and leverage while they walk up or down the stairs 105 or ramp 106. The first moveable support 51 with cross-rail assembly 110 has a first grip or bar 112 for walking upstairs, and a separate second grip or bar 115 above it for walking downstairs. An alternative grip or bar 116 is also available as an alternative for grip 112 or 115 so that an individual can use the grip that is most convenient for their height. The grip 112 is positioned lower in elevation than the grip 115 or grip 116 so that the person using the assist apparatus 50 holds onto grip or bar 112 or grip or bar 116 when going up the stairs and grip or bar 115 or grip or bar 116 when going down the stairs so that they do not have to reach up when going up the stairs or bend down when going down the stairs thereby providing the optimum posture to maintain their balance. The first moveable support 51 can be slid freely and when the locking mechanism 200 is engaged by the user it locks first moveable support 51 into place by engaging locking mechanism 200 attached to the first moveable support 51 and locking receptacle 210 in the fixed support rail track 100 a sensor 2401 incorporated into moveable support 51 is attached to the transmitter 1000 to signal to the remote wireless receiver 2000 that locking mechanism 200 has been engaged, this provides the caregiver status information on the movement of moveable support 51 along support rail track 100. Sensor 2401 technology can be selected from mechanical contacting switches, magnetic, inductive, capacitive, passive infrared, infrared, linear variable displacement transducer, magnetic, inductive, capacitive, optical, etc. devices, or others. The locked position provides stability and leverage for travel to the next step. The person using the assist apparatus 50 can move the first moveable support 51 by engaging handle on actuator 400 which is attached to link 410 and retracts locking mechanism 200 so that it retracts from locking receptacle 210 in fixed support rail track 100. Then the mobility impaired individual using the assist apparatus 50 can move the first moveable support 51 by pushing the moveable support to the next location in fixed support rail track 100 where there is a locking receptacle 210 where locking mechanism 200 is inserted in the next locking receptacle 210. The locking receptacle 210 is repeated along the fix support rail track 100 as many times as needed for the mobility impaired individual to traverse the stairs 105 or ramp 106. This locking and unlocking action is repeated to complete either the assent or decent of the stairs 105 or ramp 106. An important feature of the invention and one that was not anticipated until used by customers is the ability to rotate the cross-rail assembly 110 which is part of the first moveable support 51 so that the person can hold onto the cross-rail assembly 110 and walk either up to the top landing 4000 or down to the bottom landing 4010 by holding the grip 112 or 115 or 116. Looking at moving to top landing 4000 to achieve this the person unlocks the cross-rail assembly 110 while in the perpendicular position with respect to the fixed support rail track 100 which is the 90 degree position shown in FIG. 11 by manually moving lock 215 and raising the cross-rail assembly 110 so that pin 220 can disengage from the bottom hole 225 The cross-rail assembly 110 is now free to rotate about holding rod 230. This allows the person to take the last step up to the top landing 4000 while still holding the cross-rail assembly 110 which is now capable of rotating about holding rod 230. When the cross-rail assembly 110 is rotated about holding rod 230 and is in position 250 or 180 degrees shown in FIG. 11, the pin 220 can be reinserted into the hole 227 or rotated about holding rod 230 so that pin 220 is aligned with hole 226 for storage along wall 300 or 0 degrees shown in FIG. 11. This positions the cross-rail assembly 110 out of the way so that individuals who do not need the assist apparatus 50 can use the stairs without having to move around the assist apparatus 50. Therefore the first moveable support 51 can be selectively positioned so as to be positioned so that it points either down the incline structure in the direction of the landing which is 0 degrees, shown in FIG. 11, perpendicular to the fix support which is 90 degrees shown in FIG. 11, or pointing up the incline which is 180 degrees shown in FIG. 11. The sensor 2402 attached to the transmitter 1000 to signal to the remote wireless receiver 2000 that the cross-rail assembly 110 has been rotated about holding rod 230 and is in position 250 or 180 degrees shown in FIG. 11, additionally the sensor 2403 attached to the transmitter 1000 is capable of signaling to the remote wireless receiver 2000 that the cross-rail assembly 110 has been rotated about holding rod 230 and is in position for storage along wall 300 or 0 degrees shown in FIG. 11, this provides the caregiver status information on the movement of the movement and stored position of cross rail assembly 110. Sensor 2402 and 2403 technology can be selected from mechanical contacting switches, magnetic, inductive, capacitive, passive infrared, infrared, linear variable displacement transducer, magnetic, inductive, capacitive, optical, etc. devices, or others.

To facilitate the person walking to the lower landing the ability to rotate the first moveable cross-rail assembly 110 which is part of the first moveable support 51 so that the person can hold onto the cross-rail assembly 110 and take the last step to the bottom landing 4010 by holding the grip 112 or 115 or 116. To achieve this with the cross-rail assembly 110 in the perpendicular position with respect to the fixed support rail track 100 which is the 90 degree position shown in FIG. 11 a person unlocks the cross-rail assembly 110 by manually moving lock 215 and raising the cross-rail assembly 110 from so that pin 220 comes out of hole 225. The cross-rail assembly 110 is now free to rotate about holding rod 230. This allows the person to take the last step down to the bottom/lower landing while still holding the cross-rail assembly 110 which is capable of rotating about holding rod 230. When the cross-rail assembly 110 is rotated about holding rod 230 and is in position 260 or 0 degrees shown in FIG. 11 so pin 220 can be inserted into hole 226 or rotated about holding rod 230 so pin 220 can be inserted into hole 227 for storage along wall 300 or 180 degrees. The sensor 2403 attached to the transmitter 1000 to signal to the remote wireless receiver 2000 that the cross-rail assembly 110 has been rotated about holding rod 230 and is in position 260 or 0 degrees shown in FIG. 11, additionally the sensor 2402 attached to the transmitter 1000 can to signal to the remote wireless receiver 2000 that the cross-rail assembly 110 has been rotated about holding rod 230 and is in position for storage along wall 300 or 0 degrees shown in FIG. 11, this provides the caregiver status information on the movement of the movement and stored position of cross rail assembly 110.

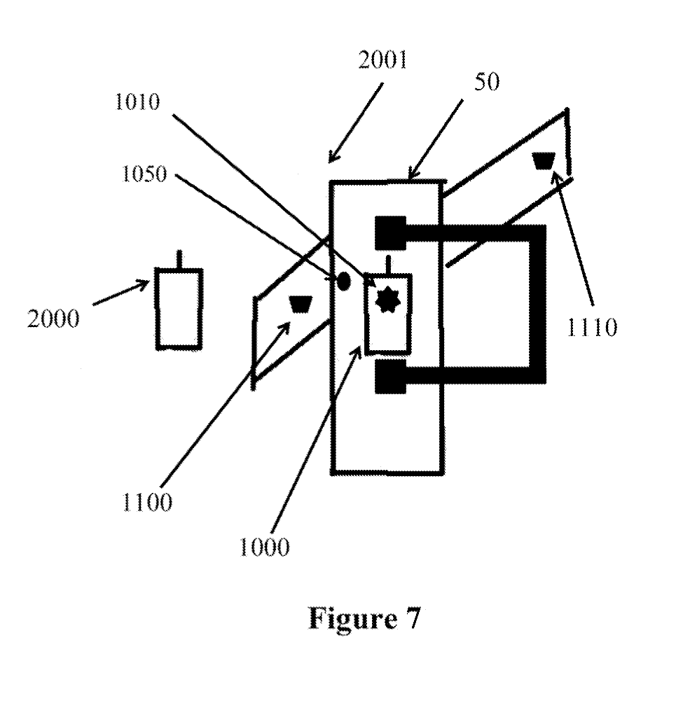

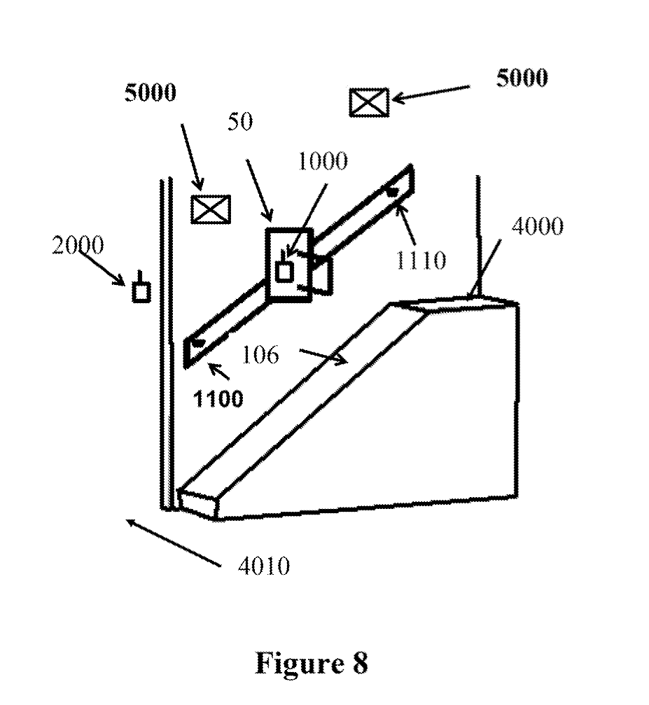

Additionally using FIGS. 7, and 8 the invention anticipates the assist apparatus 50 being used in public or private spaces inhabited by individuals who need to use the assist apparatus 50 and a caregiver or facility manager who needs to know the whereabouts of the person who they are caring for or others in the space. To achieve this, the assist apparatus 50 is equipped with a transmitter 1000 and battery 1010 and a transmitter 1001 and battery 1011 both of which are capable of sending a signal to the receiver 2000 which is carried by the caregiver or facility manager. When first moveable support 51 of the assist apparatus 50 is in transit between the two landing positions 4000 and 4010 of the stairs 105 or ramp 106 the assist apparatus 50 sends an alarm signal which then displays an alarm on the receiver 2000. This is accomplished as follows: The assist apparatus 50 is equipped with a transmitter 1000 and battery 1010 and a transmitter 1001 and battery 1011 both on fixed support rail track 100 which are capable of sending a signal by way of a wireless means 2001 to the receiver 2000 which is carried by the caregiver. When the assist apparatus 50 first moveable support 51 is not in located at landing 4000 the transmitter 1000 which is in communication with battery 1010 and is in communication with a sensor 1050 and in communication a sensor activator 1100 on first moveable support 51 will not broadcast a wireless signal to the receiver 2000. Sensor 1050 technology can be selected from mechanical contacting switches, magnetic, inductive, capacitive, passive infrared, infrared, linear variable displacement transducer, magnetic, inductive, capacitive, optical, etc. devices, or others. When the assist apparatus 50 first moveable support 51 is not in located at landing 4010 the transmitter 1000 which is in communication with battery 1010 and is in communication with sensor 1050 and in communication with sensor activator 1110 on first moveable support 51 will not broadcast a wireless signal to the receiver 2000. When at either landing 4000 or 4010 the sensor 1050 is engaged so that it is in communication with a sensor actuator 1100 at the bottom of the stairs or ramp or sensor activator 1110 at the top of the stairs or ramp and the transmitter does not send a wireless signal to receiver 2000. However, when the assist apparatus 50 is in transit the sensor 1050 is not engaged so that it is not in communication with sensor activator 1100 at the bottom of the stairs or ramp or sensor activator 1110 at the top of the stairs the ramp, the transmitter 1000 sends a wireless signal to receiver 2000. It is anticipated that sensor technology used to detect the apparatus position at the can include mechanical contacting switches, magnetic, inductive, capacitive, passive infrared, infrared, linear variable displacement transducer, magnetic, inductive, capacitive, optical, etc. devices, or others or others. It is also envisioned that a number of transmitters can be deployed along the fix support 50 so that a transmitter is present at each step of the incline structure such as stairs 105 or ramp 106. ‘Wireless’ means that the transmitter 1000 and receiver 2000 utilizes a protocol selected from the group consisting IEEE 802.15.4 standard, ZigBee, International Society of Automation's ISA100 11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or other radio frequency system. Other power supply methods other than battery 1010 are also envisioned by the invention including a permanent connection to the power in the house or a vibration stimulate energy harvester as described in U.S. Pat. No. 8,665,042, U.S. Pat. No. 8,324,998, and U.S. Patent Application 2008/0129153 the contents of which are incorporated herein by reference in its entirety. It is also anticipated that the signal could be reversed so that the transmitter 1000 which is in communication with battery 1010 and is in communication with switch 1050 will broadcast a wireless signal to the receiver 2000 when switch actuator 1100 at the bottom of the stairs or ramp or switch actuator 1110 at the top of the stairs or ramp and the transmitter 1000 sends a wireless signal to receiver 2000. This is the reverse logic to the preferred embodiment. Also, a plurality of actuators can be deployed along the fix support 50 so that an actuator is present at each step of the incline structure such as stairs 105 or ramp 106. In addition to top and bottom switches additional actuators, sensors or switches can be attached to the apparatus including but not limited to, switches or actuators at each step to provide location information of the user while in transit. The switch 9010 is associated with locking receptacle 210 which is repeated along the fix support rail track 100 as many times as needed for the mobility impaired individual to traverse the stairs 105 or ramp 106. Additional features at the monitoring receiver can be added including but not limited to a timing feature that will provide notification that the user has arrived or has not arrived at the logical position within an expected time frame. Additionally a notification device 5000 can be attached to transmitter 1000 such that it is available to the person using the stair assist apparatus so they can wirelessly communicate with their caregiver signaling that they need assistance. The notification device 5000 can be either a two way wireless system allowing voice communication or a simple alarm activation device that sends a signal to receiver 2000. Wherein said wireless receiver and transmitter protocol is selected from the group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or other radio frequency system.

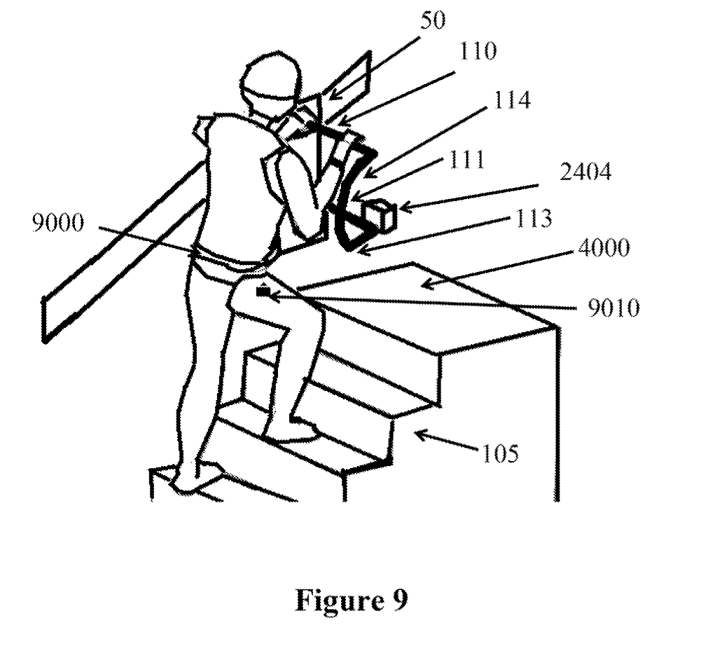

Additionally, using FIGS. 9 and 11 the invention provides for a second moveable support 111 attached to the cross-rail assembly 110 such that it can rotate from 0 to 180 degrees about the distal end of cross-rail assembly 110 so that it can provide additional support to the person walking on the stairs 105 or ramp 106 when locked in the 0 degree and 180 degree position. The degree positions being defined as shown in FIG. 11 0 degrees pointing down the inclined structure, 90 degrees is perpendicular to the fixed support and 180 degrees is pointing up the inclined structure. The second moveable support 111 formed from articulating member 114 and 113 attached to the cross-rail assembly 110 which is attached to the first moveable support 51 can rotate by releasing locking mechanism 3000 so that it disengages and allows second articulating member 111 to rotate and sensor 2404 is attached to cross-rail assembly 110 such that it can sense that second articulating member 111 has rotated. When the person is at the top of the stairs 105 or ramp 106 they release locking mechanism 3000 and disengage the articulating member 114 and 113 so they can rotate. This allows them a second handhold so that they remain in control when stepping up to the landing 4000, the sensor 2404 simultaneously can transmit the direction and status of the rotation of second articulating member 111 to wireless receiver 2000. When the person is at the bottom of the stairs 105 or ramp 106 they release locking mechanism 3000 and disengage the second articulating member 114 and 113 so they can rotate. This allows them a second hand hold so that they remain in control when stepping down to the landing 4010 the sensor 2404 simultaneously can transmit the direction and status of the rotation of second articulating member 111 to wireless receiver 2000.

FIG. 9 also displays the user wearing a removable harness 9000 around their waist that is attached to the cross-rail assembly 110. This harness will prevent the user from moving past the present or subsequent locking receptacle on the rail in the event the user loses grip of the cross-rail. This prevents uncontrolled movement or falls past the assist apparatus if the user becomes unsteady or falls when they lose total grip of the cross-rail. The user can also wear one or more sensors 9010 in communication with the wireless communication system to communicate the physiological status or location of the user to a remote wireless receiver 1000 by way of the wireless transmitter 2000. Sensor 9010 can be selected from a variety of available sensors including Polar H7 Bluetooth Low Energy heart rate monitor, Zephyr Technology's BioHarness BT sensor technology is capable of biometric monitoring including blood oxygen, ECG, and blood pressure. A wireless communication system configured with sensors and two way information exchanges can provide real time monitoring of these physiological conditions and other needs to a caregiver or user remotely located from the assist apparatus.

Sensors 9010 technology can be selected from mechanical contacting switches, magnetic, inductive, capacitive, passive infrared, infrared, linear variable displacement transducer, magnetic, inductive, capacitive, optical, shock, vibration, accelerometer etc. devices, or others.

Additionally the using FIG. 9 fixed support rail track 100, first moveable support 51, the second moveable support 111 and removable harness 9000 form a 4 way support for the person using the assist apparatus 50.

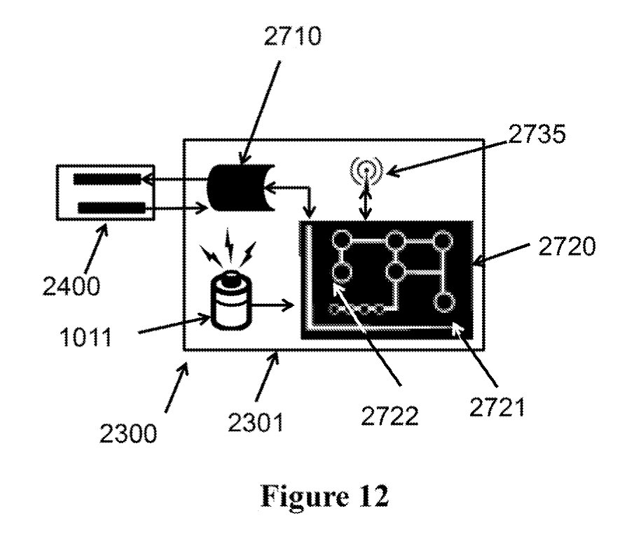

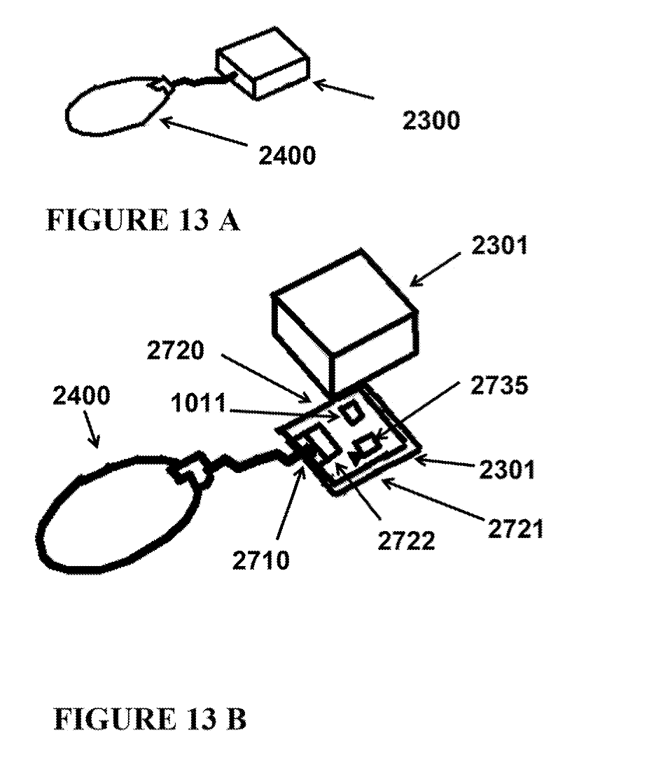

As seen in FIG. 12, FIGS. 13 A and 13 B schematics showing the typical remote transmitter device using the transmitter 1000 for the stair assist device as an example. The transmitter 1000 is comprised of the plastic housing 2301 and 2300, electronics board 2720 which has the selected communication protocol 2721 built into it, protocol is selected from the group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or other radio frequency system. Electronic board 2720 is the two way signal transmitter that can send and receive information to the wireless signal to receiver 2000 shown in FIG. 7 and it is coupled to the housing 2301. A sensor control section 2722 is coupled to the housing 2301 which is in communication to a sensor connector 2710 and it is coupled to the housing 2301 which is in communication with the sensor 2400. Housing 2300 is a cover to protect Electronic board 2720. Sensor 2400 can be the any sensor that is attached to the assist apparatus 50. A battery 1011 is in communication with electronics board 2720 and provides power for the electronics package for electronics board 2720. An antenna 2735 is attached to electronics board 2720 which is in communication with smart phone or tablet 50 not shown. Battery 1011 can either be a primary battery such as an alkaline battery or a rechargeable battery such as a li-ion battery.

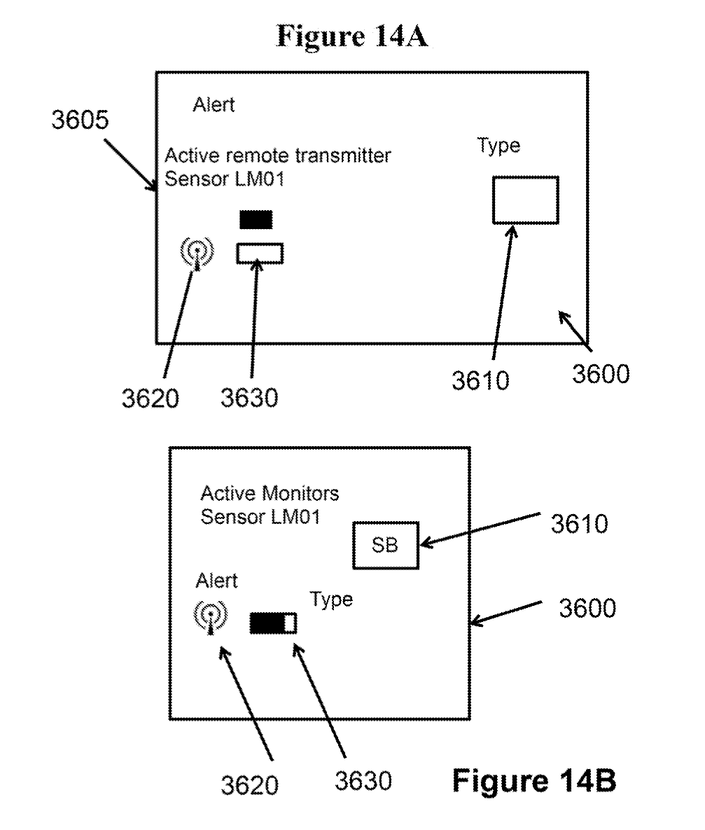

As illustrated in FIG. 14A, the wireless receiver 2000 linking screen which is shown for linking the transmitter 1000 to wireless receiver 2000, the wireless receiver 2000 can alternatively be smart phone or tablet. The screen 3600 shows the active remote transmitters available 3605 and data input place 3810. It also shows that it is communicating with antenna icon 3620 and that the battery life icon 3630 in the remote transmitter is acceptable. The wireless receiver 2000 can link to as many sensors as it needs to but ideally no more than 5 sensors are linked to one wireless receiver 2000.

As illustrated in FIG. 14B, the wireless receiver 2000 screen for communicating information is shown. The wireless receiver 2000 for linking the remote transmitter to, in this case stair assist apparatus 50 is shown. The screen 3600 shows the active remote transmitters available 3605 and data input place 3610. The caregiver has entered a SB for stair assist bottom in data input place 3610. The caregiver would enter ST for stair assist top. The wireless receiver 2000 can link to as many sensors as it needs to but ideally no more than 5 sensors are linked to wireless receiver 2000.

### OTHER EMBODIMENTS

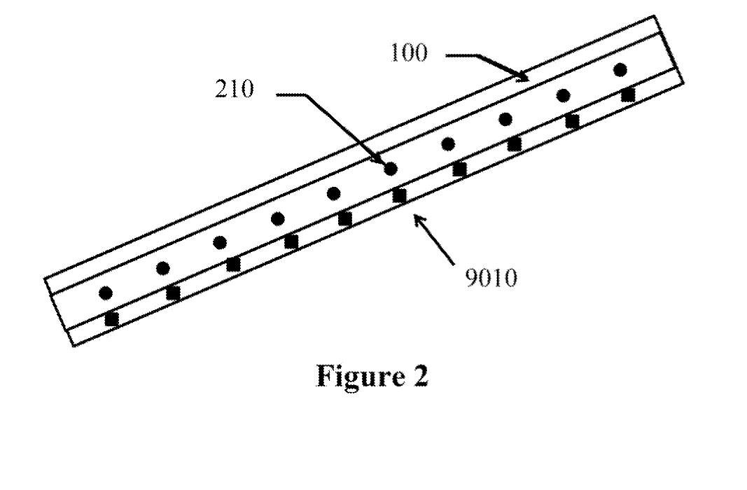

In an alternate embodiment, this apparatus can be used to move up or down a ramp instead of stairs as shown in FIG. 2.

In an alternate embodiment that uses a lock mechanism that latches into a solid vertical feature parallel to the wall with a rigid surface perpendicular to the wall with a vertical movement of the cross-rail.

In an alternate embodiment includes a spring mechanism to stabilize and meter vertical movement of the cross-rail.

In an alternate embodiment uses a metal track and ball bearing as part of the moveable support.

In an alternate embodiment uses two parallel tracks to support the cross-rail assembly.

In an alternate embodiment of the cross-rail assembly includes multiple parallel rails to accommodate users of different heights.

In an alternate embodiment includes a hinge so that the cross-rail can rotate about an axis parallel to the wall to clear the path of the stairway.

In an alternate embodiment includes a bracket and pocket/slot so that the cross-rail may be removed from the moveable support when not in use.

In an alternate embodiment of the cross-rail omits the end section, the support bar, or both.

An alternate embodiment may use alternative locking/unlocking mechanisms and actuators, including a cable and lever arrangement.

In an alternate embodiment, achieve the unlocked position by use of alternative restraints to hold the lock mechanism in the unlocked position, such as a slide, or clip.

In an alternate embodiment, the top and bottom locating switches use non-contacting technology such as mechanical contacting switches, magnetic, inductive, capacitive, passive infrared, infrared, linear variable displacement transducer, inductive, capacitive, optical, etc. devices.

In an alternate embodiment, the transmitter is powered by an energy harvesting device and signal is broadcast anytime the moveable support assembly is in motion.

In an alternate embodiment the front plate of moveable support rotates around the center of the moveable support to accommodate different stair or ramp pitches and then locked in position with a locking mechanism.

In an alternate embodiment the track contains a counter weight or spring attached to the moveable support so force required to move the movable support can be adjusted.

In an alternate embodiment there are multiple switches or sensors mounted to the apparatus so the rate and position of the persons' movement can be calculated to indicate a fall or other emergency situations.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all other embodiments falling within the scope of this disclosure, but that various changes and modifications may be made without departing from the scope of the inventions as are set forth in the following claims.

What is claimed is:

1. An assist apparatus capable of transmitting information regarding the apparatus and the individual using the assist apparatus relative to the traversal of an inclined structure using a wireless communication device with a wireless protocol in communication with a wireless receiver further comprising a fixed support rail track that is fixed relative to the inclined structure and a low friction first movable support that is in communication with the fixed support rail track and said first movable support moves relative to the fixed support rail track along the axis substantially parallel to the pitch of the inclined structure such that said first movable support having a locking mechanism cooperating with mating locking receptacle in said fixed support rail track for the releasable locking of the first movable support against movement along the longitudinal axis of the fixed support rail track and a sensor in communication with said wireless communication device capable of transmitting the location of the first moveable support with respect to the fix support rail track and said first movable support having a cross-rail assembly perpendicular to the fixed rail support track comprising of a bar or grip distal from the pitch of the inclined structure and at least a second bar or grip parallel to the first bar or grip and positioned proximal to the pitch of said inclined structure and wherein said first movable support further having a selectable lock that permits the cross-rail assembly to be capable of selectively being positioned so that it points either down the incline structure in the direction of the bottom landing which is 0 degrees or perpendicular to the fixed support rail track which is 90 degrees or pointing up the incline in direction of the top landing which is 180 degrees and a sensor capable of communication with said wireless transmitter capable of transmitting the location relative to the first movable support with respect to the cross-rail assembly and the direction the cross-rail assembly points indicating either perpendicular to the incline structure, down the incline structure or up the incline structure and wherein said first movable support further comprises of a second movable support attached to the distal end of the cross-rail assembly comprising of an articulating member substantially parallel to the fixed support rail track and perpendicular to the cross-rail assembly and parallel to and positioned distal to the pitch of the inclined structure and at least one other articulating member which is also perpendicular to the cross-rail assembly and parallel to the first articulating member and parallel to and positioned proximal to the pitch of the inclined structure and a sensor in communication with said first articulating member so as to read the relative location of the first articulating member with respect to the cross rail and said sensor in communication with said wireless transmitter capable of wirelessly transmitting the position information of said second movable support with respect to said cross-rail assembly and said first movable support.

2. The apparatus of claim 1 further comprising of a said wireless communication device having a wireless transmitter utilizing a wireless protocol that communicates with a remote wireless receiver and said wireless transmitter capable of communication with sensors on said first movable support rail track, on the cross-rail assembly, on a second movable support and on the user to provide location and status information to a caregiver about the first movable support or the cross-rail assembly or the second movable support or the user such that said status information is transmitted to said wireless receiver.

3. The apparatus of claim 1 further comprising of a plurality of sensors in communication with the wireless transmitter which is in communication with a wireless receiver and said wireless transmitter being selectively in communication with a plurality of locking receptacles located on the fixed support rail track such that the moving portion can transit from one locking receptacle to at least one other locking receptacle in the fixed support rail track and the said sensors in communication with the wireless transmitter can communicate the location of the moving portion relative to the fixed support rail track and the status of the locking receptacles of the fixed rail track to the wireless transmitter such that said position along the fixed rail track is transmitted to said wireless receiver.

4. The apparatus of claim 1 further comprising an actuator in communication with a sensor in communication with a wireless transmitter utilizing a wireless protocol that communicates with a remote wireless receiver and said actuator causing the locking mechanism of the movable support to be engaged with the locking receptacle of the fix support and said sensor providing location of the movable support to said wireless transmitter that communicates the status to a remote wireless receiver.

5. The apparatus of claim 1 wherein said first movable support further comprising a cross-rail assembly in communication with a sensor on said first movable support and said sensor in communication with a wireless transmitter utilizing a wireless protocol that communicates with a remote wireless receiver wherein said movable support is comprised of a locking mechanism and said cross-rail assembly has a secondary locking receptacle located such that the cross-rail assembly locking receptacle is selectively lockable to the first movable support locking mechanism on the first movable support such that it can be selectively positioned so as to be positioned such that the cross-rail assembly can point either down the incline structure in the direction of the bottom landing which is 0 degrees perpendicular to the fix support rail track which is 90 degrees or pointing up the incline in the direction of the top landing which is 180 degrees and has at least one cross-rail assembly support bar or grip which is also parallel to the first cross-rail assembly support bar or grip wherein the said sensor in communication with the wireless communication system can communicate the position of the cross-rail assembly relative to the movable support or the fixed rail track or the user to a remote location.

6. The apparatus of claim 1 wherein the cross-rail assembly is in communication with a second movable support and at least one sensor in communication with a wireless transmitter utilizing a wireless protocol that communicates with a remote wireless receiver such that the sensor can communicate the relative position of the second movable support relative to the cross-rail assembly or the first movable support or the fixed support rail track or the user.

7. The apparatus of claim 1 wherein first movable support is in communication with both the cross-rail assembly and the fixed support rail track and a harness and a sensor in communication with communication with a wireless transmitter utilizing a wireless protocol that communicates with a remote wireless receiver such that the harness is attached between the first movable support and the user such that the user is supported proximal to the first movable support and the cross-rail assembly and fixed support rail track and said sensor in communication with the wireless transmitter can communicate the status and location of the user relative to the first movable support or the cross-rail assembly or the fixed rail track or the second movable support to a remote location.

8. The apparatus of claim 1 wherein the support bar or grip of the cross-rail assembly is perpendicular to the fixed support rail track and distal from the pitch of the inclined structure and is located to allow a person to hold it during traversal down an inclined structure and a second support bar or grip of the cross-rail assembly parallel to the first support bar and positioned proximal to the pitch of the inclined structure to allow a person to hold it during traversal up an inclined structure and said cross-rail assembly contains a sensor in communication with a wireless transmitter utilizing a wireless protocol that communicates with a remote wireless receiver and can communicate the support bar position relative to the of the second support bar to a caregiver.

9. The apparatus of claim 1, wherein the cross-rail assembly support bar or grip includes a sensor in communication with a wireless transmitter utilizing a wireless protocol that communicates with a remote wireless receiver and said cross-rail assembly can rotate so that the person can hold onto the support bar or grip and walk down to the bottom landing of the inclined structure and said sensor and can communicate the relative position of the cross-rail assembly to the first movable support or fixed track rail or second movable support or user to a remote location using said wireless transmitter.

10. The apparatus of claim 1 wherein cross-rail assembly support bar or grip includes a sensor in communication with a wireless transmitter utilizing a wireless protocol that communicates with a remote wireless receiver and said cross-rail assembly can rotate so that the person can hold onto the support bar or grip and walk up to the top landing of the inclined structure and said sensor can communicate the relative position of the cross-rail assembly to the first movable support or fixed track rail or second movable support or individual to a remote location using said wireless transmitter.

11. The apparatus of claim 1 wherein the user wears one or more sensors in communication with a wireless transmitter utilizing a wireless protocol that communicates with a remote wireless receiver to communicate the physiological status or location of the user to a remote location using the wireless transmitter.

12. The apparatus of claim 1 wherein the apparatus incorporates a plurality of wireless transmitters on said fixed support rail that is capable of transmitting wirelessly signals to a remote wireless receiver using a wireless protocol and said first movable support has an actuator which is capable of selectable communication with the wireless transmitters on said fixed support rail such that the transmitters communicates with a remote wireless receiver when said actuator is in communication with said wireless transmitter.

13. The apparatus of claim 1, wherein the apparatus incorporates a plurality of actuators on said fixed support rail such that each actuator is capable of communication with a wireless transmitter on said movable support when said moveable support is in communication with the actuator such that when said actuators are selectively in communication with said transmitter it transmits wirelessly signals to a remote wireless receiver using a wireless protocol and said transmitter is capable of selectable communication with the remote wireless receiver when said actuator is in communication with said wireless transmitter and said wireless receiver and transmitter communicate using a wireless protocol.

14. The apparatus of claim 10, wherein said wireless protocol is a radio frequency selected from a group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM).

15. The apparatus of claim 11, wherein said wireless protocol is a radio frequency selected from a group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM).

16. The apparatus of claim 1, wherein said wireless protocol is selected from a group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM) or infrared modulation.

17. The apparatus of claim 1, wherein the apparatus incorporates a wireless transmitter on said first support that is capable of transmitting wirelessly signals to a remote wireless receiver by way of a wireless transmitter protocol, wherein said wireless protocol is selected from a group consisting of IEEE 802.15.4 standard, ZigBee, International Society of Automation's ISA100.11a, 6LoWPAN, Internet Protocol (IPv6), Z-Wave, X10, Insteon, Bluetooth low energy (BLE), WI-FI, Bluetooth, Near Field Communication, DTMF (dual tone multi frequency), frequency modulation of analog signal (FM) or amplitude modulation of an analog signal (AM).

18. The apparatus of claim 1, wherein the apparatus incorporates a wireless notification system that consists of a two way wireless protocol that is capable of transmitting voice information to a receiving wireless transmitter by way of a wireless protocol.

19. The apparatus of claim 11, wherein said wireless transmitter is in communication with said wireless receiver such that wireless transmitter sends a notification to said wireless receiver with each incidence of coming in contact with said actuator.

20. The apparatus of claim 1, wherein said wireless transmitter is in communication with said wireless receiver and said wireless receiver provides a means of displaying status information about said sensor.
